(19) United States
(12) Patent Application Publication
(10) Pub. No.: US 2024/0246759 A1
(43) Pub. Date: Jul. 25, 2024

(54) APPARATUSES AND DEVICES FOR FACILITATING DISPENSING OF APPLICATORS

(71) Applicant: LaQuaecia Brashae Rudd, Gretna, NE (US)

(72) Inventor: LaQuaecia Brashae Rudd, Gretna, NE (US)

(21) Appl. No.: 18/099,978

(22) Filed: Jan. 23, 2023

(51) Int. Cl. B65G 1/04; A45D 40/00

(52) U.S. Cl. CPC B65G 1/04; A45D 40/00

(57) ABSTRACT

An apparatus for facilitating dispensing of applicators. The apparatus includes a base, a support member, a holding element, a movement mechanism, and an actuating device. The base is disposable on a surface. The apparatus is placed on the surface based on the disposing. The support member is coupled to the base. The holding element is movably coupled to the support member and configured for holding an applicator. The movement mechanism is coupled to the holding element and the support member and configured for moving the holding element along the support member from a first position to a second position. The moving moves the applicator from a first applicator position to a second applicator position based on the holding. The actuating device is operatively coupled with the movement mechanism and configured for actuating the movement mechanism. The moving of the holding element is based on the actuating.

### FIELD OF THE INVENTION

Generally, the present disclosure relates to the field of article dispensing. More specifically, the present disclosure relates to apparatuses and devices for facilitating dispensing of applicators.

### BACKGROUND OF THE INVENTION

The field of article dispensing is technologically important to several industries, business organizations, and/or individuals. In particular, the use of article dispensing is prevalent for dispensing applicators.

Existing techniques for facilitating dispensing of applicators are deficient with regard to several aspects. For instance, current apparatuses are only designed for dispensing applicators. As a result, different apparatuses are needed that dispense the applicators with accompanying specific sounds. Furthermore, current apparatuses are designed for dispensing applicators by moving the applicators to a general position. As a result, different apparatuses are needed that determine a position for moving the applicators based on the user's characteristics and then move the applicators to that position for dispensing the applicators. Moreover, current apparatuses are designed for dispensing applicators with a general sound. As a result, different apparatuses are needed that determine the position to which the applicators are to be moved based on the user's characteristics and then create sounds accompanying the moving of the applicators to that position based on the position and presenting that sounds during the moving of the applicators for dispensing the applicators.

Therefore, there is a need for improved apparatuses and devices for facilitating dispensing of applicators that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating dispensing of applicators, in accordance with some embodiments. Accordingly, the apparatus may include a base, a support member, a holding element, a movement mechanism, and an actuating device. Further, the base may include a bottom surface and a top surface opposing the bottom surface. Further, the base may be disposable on a surface. Further, the apparatus may be placed on the surface based on the disposing of the base. Further, the support member may be coupled to the base. Further, the support member extends between a first end and a second end. Further, the first end of the support member may be attached to the top surface. Further, the second end of the support member extends away from the top surface. Further, the holding element may be movably coupled to the support member. Further, the holding element may be configured for holding an applicator. Further, the movement mechanism may be coupled to the holding element and the support member. Further, the movement mechanism may be configured for moving the holding element along the support member from a first position of the holding element to at least one second position of the holding element. Further, the moving of the holding element moves the applicator from a first applicator position of the applicator to at least one second applicator position of the applicator based on the holding. Further, the first position corresponds to the first applicator position and the at least one second position corresponds to the at least one second applicator position. Further, the actuating device may be operatively coupled with the movement mechanism. Further, the actuating device may be configured for actuating the movement mechanism. Further, the moving of the holding element may be based on the actuating.

Further disclosed herein is an apparatus for facilitating dispensing of applicators, in accordance with some embodiments. Accordingly, the apparatus may include an applicator, a base, a support member, a holding element, a movement mechanism, and an actuating device. Further, the applicator may include an applicator housing. Further, the applicator housing may include an applicator housing base and an applicator housing body. Further, the applicator housing body may be cylindrically shaped. Further, the base may include a bottom surface and a top surface opposing the bottom surface. Further, the base may be disposable on a surface. Further, the apparatus may be placed on the surface based on the disposing of the base. Further, the support member may be coupled to the base. Further, the support member extends between a first end and a second end. Further, the first end of the support member may be attached to the top surface. Further, the second end of the support member extends away from the top surface. Further, the holding element may be movably coupled to the support member. Further, the holding element may be configured for holding the applicator. Further, the movement mechanism may be coupled to the holding element and the support member. Further, the movement mechanism may be configured for moving the holding element along the support member from a first position of the holding element to at least one second position of the holding element. Further, the moving of the holding element moves the applicator from a first applicator position of the applicator to at least one second applicator position of the applicator based on the holding. Further, the first position corresponds to the first applicator position and the at least one second position corresponds to the at least one second applicator position. Further, the actuating device may be operatively coupled with the movement mechanism. Further, the actuating device may be configured for actuating the movement mechanism. Further, the moving of the holding element may be based on the actuating.

Further disclosed herein is an apparatus for facilitating dispensing of applicators, in accordance with some embodiments. Accordingly, the apparatus may include an applicator, a base, a support member, a holding element, a movement mechanism, and an actuating device. Further, the applicator may include an applicator housing. Further, the applicator housing may include an applicator housing base and an applicator housing body. Further, the applicator housing body may be cylindrically shaped. Further, the applicator may be a cosmetic product applicator. Further, the base may include a bottom surface and a top surface opposing the bottom surface. Further, the base may be disposable on a surface. Further, the apparatus may be placed on the surface based on the disposing of the base. Further, the support member may be coupled to the base. Further, the support member extends between a first end and a second end. Further, the first end of the support member may be attached to the top surface. Further, the second end of the support member extends away from the top surface. Further, the support member may include an interior space extending between the first end of the support member and the second end of the support member. Further, the holding element may be movably coupled to the support member. Further, the holding element may be configured for holding the applicator. Further, the movement mechanism may be coupled to the holding element and the support member. Further, the movement mechanism may be configured for moving the holding element along the support member from a first position of the holding element to at least one second position of the holding element. Further, the moving of the holding element moves the applicator from a first applicator position of the applicator to at least one second applicator position of the applicator based on the holding. Further, the first position corresponds to the first applicator position and the at least one second position corresponds to the at least one second applicator position. Further, the movement mechanism may be disposed in the interior space. Further, the movement mechanism may include a spring and a latch assembly. Further, the spring may include a first end and a second end. Further, the first end of the spring may be attached to the first end of the support member. Further, the spring may be configured for transitioning to a natural state of the spring from at least one stressed state of the spring. Further, the natural state corresponds to the first state and the at least one stressed state corresponds to the at least one second state. Further, the latch assembly may include a hook element and a loop element. Further, the loop element may be attached to the second end of the spring. Further, the hook element may be configured to be disengagedly engaged with the loop element. Further, the actuating device may be operatively coupled with the movement mechanism. Further, the actuating device may be configured for actuating the movement mechanism. Further, the moving of the holding element may be based on the actuating. Further, the hook element may be configured for disengaging from the loop element based on the actuating. Further, the transitioning of the spring to the natural state from the at least one stressed state may be based on the disengaging. Further, the moving of the holding element along the support member may be based on the transitioning of the spring to the natural state from the at least one stressed state.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top perspective view of an apparatus 100 for facilitating dispensing of applicators, in accordance with some embodiments.

FIG. 2 is a bottom perspective view of the apparatus 100, in accordance with some embodiments.

FIG. 3 is a side perspective view of the apparatus 100, in accordance with some embodiments.

FIG. 4 is a partial view of the support member 104 of the apparatus 100, in accordance with some embodiments.

FIG. 5 is a top view of the holding element 106 of the apparatus 100, in accordance with some embodiments.

FIG. 6 is a bottom perspective view of the apparatus 100, in accordance with some embodiments.

FIG. 7 is a bottom perspective view of the apparatus 100, in accordance with some embodiments.

FIG. 8 is a bottom perspective view of the apparatus 100, in accordance with some embodiments.

FIG. 9 is a top perspective view of the receiving element 506 of the holding element 106, in accordance with some embodiments.

FIG. 10 is a partial bottom perspective view of the base 102 of the apparatus 100, in accordance with some embodiments.

FIG. 11 is a partial rear view of the base 102 of the apparatus 100, in accordance with some embodiments.

FIG. 12 is a top perspective view of an apparatus 1200 for facilitating dispensing of applicators, in accordance with some embodiments.

FIG. 13 is a top perspective view of an apparatus 1300 for facilitating dispensing of applicators, in accordance with some embodiments.

FIG. 14 is an illustration of an online platform consistent with various embodiments of the present disclosure.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of apparatuses and devices for facilitating dispensing of applicators, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the processing device may include a processor, a microprocessor, a microcontroller, a processing unit, etc. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. an indoor location sensor, etc.), and a biometric sensor (e.g. a fingerprint sensor).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

### Overview:

The present disclosure describes apparatuses and devices for facilitating dispensing of applicators.

Further, the present disclosure describes an ornamentally shaped (such as rocket launcher-shaped) apparatus configured for accommodating and ejecting a lipstick tube using a movement mechanism (such as a spring mechanism). Further, the spring mechanism is configured for ejecting the lipstick based on the pushing of a button (actuating device or input device) by a user. Further, the apparatus may include a rocket-shaped lipstick tube (applicator) attached to a lipstick holder (rocket launcher shaped) that accommodates the lipstick. Further, the lipstick holder may include a support member and a base. Further, the lipstick tube rises along the lipstick holder. Further, the apparatus may include a speaker for producing sound (identical to a rocket taking off) as the lipstick tube is moved using the lipstick holder. Further, the apparatus comprises a microcontroller for controlling the operations (such as producing sound) of the apparatus. Further, the apparatus may include a charging port for recharging a rechargeable battery of the apparatus.

Further, the present disclosure describes a lipstick holder and a lipstick tube. Further, the lipstick holder moves the lipstick tube placed on the lipstick holder with a press of a button on the lipstick holder. Further, the lipstick tube moves up the lipstick holder similar to a rocket taking off. Further, the lipstick holder also produces a sound of a rocket taking off during the movement of the lipstick tube. Further, the lipstick holder comprises a lid on the back of the lipstick holder. Further, the lipstick holder comprises a spring actuation system (movement mechanism) disposed in the lipstick holder. Further, the spring actuation system comprises a notch (the triangular part connected to the button) (hook element) that moves towards a gap (of a loop element) with the press of the button. Further, the spring actuation system comprises a rocket holder piece (holding element) that goes up due to the potential energy on the spring. Further, the button is also connected to an electronic system of the lipstick holder. Further, the lipstick holder comprises a lid at the bottom. Further, removing the lid reveals the electronic system disposed in the bottom. Further, the electronic system may include a rechargeable battery, a speaker, and a microcontroller. Further, the lipstick holder includes a charging port connected to the rechargeable battery for charging the rechargeable battery.

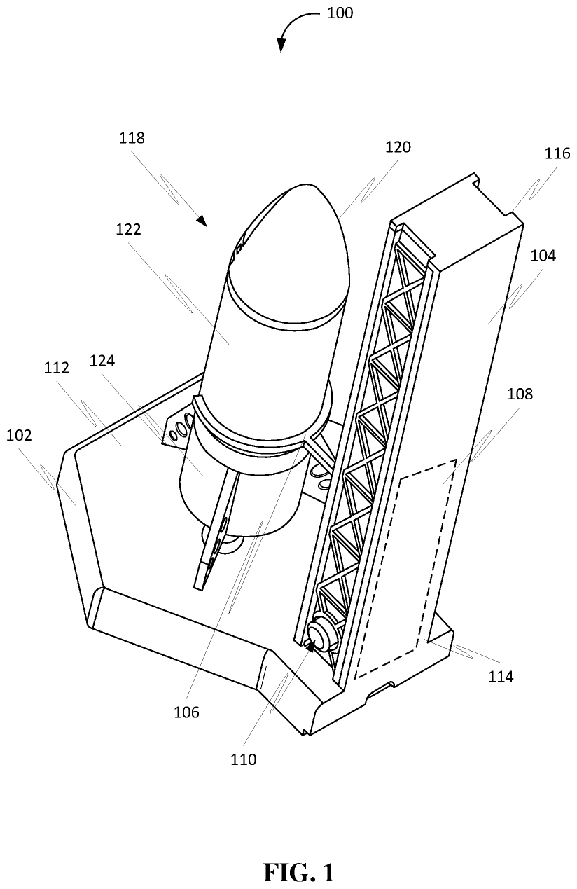

FIG. 1 is a top perspective view of an apparatus 100 for facilitating dispensing of applicators, in accordance with some embodiments. Accordingly, the apparatus 100 may include a base 102, a support member 104, a holding element 106, a movement mechanism 108, and an actuating device 110.

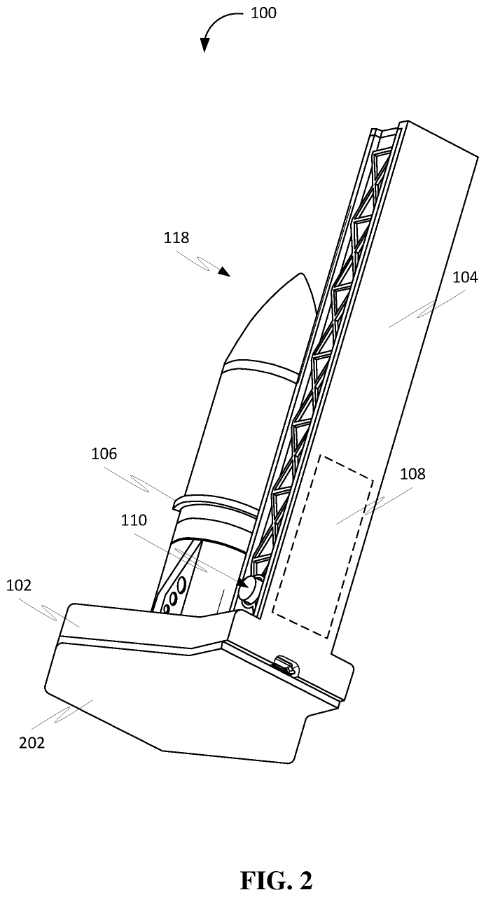

Further, the base 102 may include a bottom surface 202 (as shown in FIG. 2) and a top surface 112 opposing the bottom surface 202. Further, the base 102 may be disposable on a surface. Further, the apparatus 100 may be placed on the surface based on the disposing of the base 102. Further, the base 102 may be a flattened body. Further, the bottom surface 202 opposes the surface based on the disposing.

Further, the support member 104 may be coupled to the base 102. Further, the support member 104 extends between a first end 114 and a second end 116. Further, the first end 114 of the support member 104 may be attached to the top surface 112. Further, the second end 116 of the support member 104 extends away from the top surface 112. Further, the support member 104 may be an elongated body. Further, the support member 104 may be perpendicular to the bottom surface 202.

Further, the holding element 106 may be movably coupled to the support member 104. Further, the holding element 106 may be configured for holding an applicator 118. Further, the applicator 118 may include a lipstick tube, an eyeliner pencil, a nail polish bottle, etc. Further, the applicator 118 may include a device used for applying at least one substance. Further, the at least one substance may include a cosmetic material such as pigmented wax, oil, etc.

Further, the movement mechanism 108 may be coupled to the holding element 106 and the support member 104. Further, the movement mechanism 108 may be configured for moving the holding element 106 along the support member 104 from a first position of the holding element 106 to at least one second position of the holding element 106. Further, the moving of the holding element 106 moves the applicator 118 from a first applicator position of the applicator 118 to at least one second applicator position of the applicator 118 based on the holding. Further, the first position corresponds to the first applicator position and the at least one second position corresponds to the at least one second applicator position. Further, in an instance, the movement mechanism 108 may include a servo motor, a stepper motor, a linear motor, an electrically actuated spring mechanism, a manually actuated spring mechanism, etc. Further, in an instance, the movement mechanism 108 may be configured for moving the holding element 106 along the support member 104 from the at least one second position to the first position after the moving of the holding element 106 along the support member 104 from the first position to the at least one second position.

Further, the actuating device 110 may be operatively coupled with the movement mechanism 108. Further, the actuating device 110 may be configured for actuating the movement mechanism 108. Further, the moving of the holding element 106 may be based on the actuating.

Further, in some embodiments, the actuating device 110 may include an input device. Further, in an instance, the input device may include a button disposed on the support member 104. Further, the input device may be configured for receiving an input action. Further, the input action may include a pressing action on the button from a user. Further, the actuating of the movement mechanism 108 may be based on the receiving of the input action.

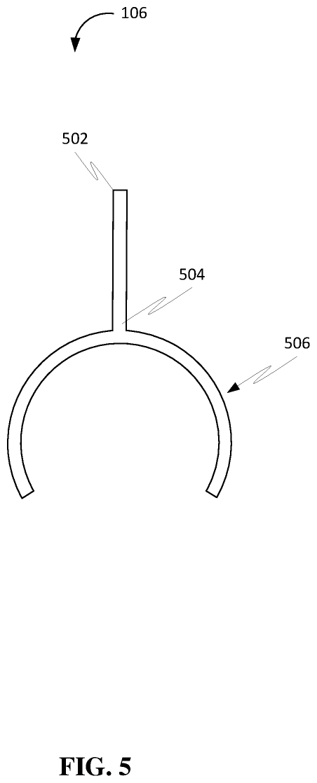

Further, in some embodiments, the holding element 106 extends between a first end 502 and a second end 504, as shown in FIG. 5. Further, the first end 502 of the holding element 106 may be coupled to the movement mechanism 108. Further, the holding element 106 may include a receiving element 506, as shown in FIG. 5, comprised in the second end 504 of the holding element 106. Further, the receiving element 506 may be configured for receiving the applicator 118 for securing the applicator 118 to the holding element 106. Further, the holding of the applicator 118 may be based on the securing. Further, in an instance, the receiving element 506 may be configured for wrapping around the applicator 118 in at least a part based on the receiving of the applicator 118 for the securing of the applicator 118.

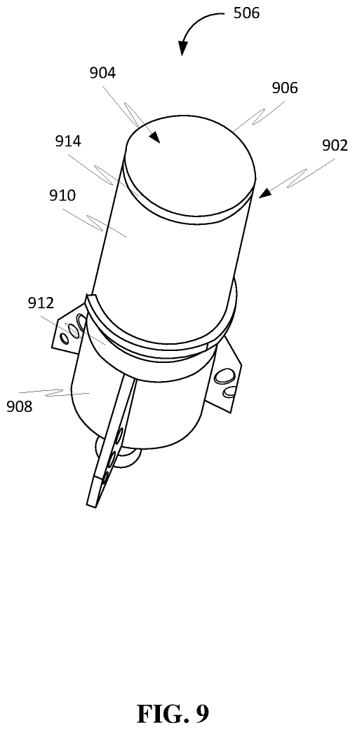

Further, in an embodiment, the receiving element 506 may include a housing 902, as shown in FIG. 9. Further, the housing 902 may include a housing interior space 904 and a housing opening 906, as shown in FIG. 9, leading into the housing interior space 904. Further, the housing 902 may be configured for receiving the applicator 118 in the housing interior space 904. Further, the receiving of the applicator 118 may be based on the receiving of the applicator 118 into the housing interior space 904. Further, in an instance, the housing 902 may be shaped like a rocket.

Further, in an embodiment, the housing 902 may include a housing base 908 and a housing body 910, as shown in FIG. 9. Further, the housing base 908 may be attached to a first end 912 of the housing body 910. Further, the housing body 910 defines the housing interior space 904. Further, the housing body 910 defines the housing opening 906 at a second end 914 of the housing body 910. Further, the housing body 910 may be cylindrically shaped. Further, in an instance, the housing base 908 may include fins protruding away from the housing base 908.

In further embodiments, the apparatus 100 may include the applicator 118. Further, the applicator 118 may be securable to the holding element 106. Further, the applicator 118 may include an applicator housing 120. Further, the applicator housing 120 may include an applicator housing base 124 and an applicator housing body 122. Further, the applicator housing body 122 may be cylindrically shaped. Further, in an embodiment, the applicator 118 may be removably securable to the holding element 106. Further, in an instance, the applicator housing 120 may be shaped like a rocket. Further, in an instance, the applicator housing base 124 may include fins protruding away from the applicator housing base 124.

Further, in some embodiments, the holding element 106 may be configured for releasably holding the applicator 118. Further, in an instance, the receiving element 506 may be configured for detachably wrapping around the applicator 118 in at least a part based on the receiving of the applicator 118 for the releasably securing of the applicator 118.

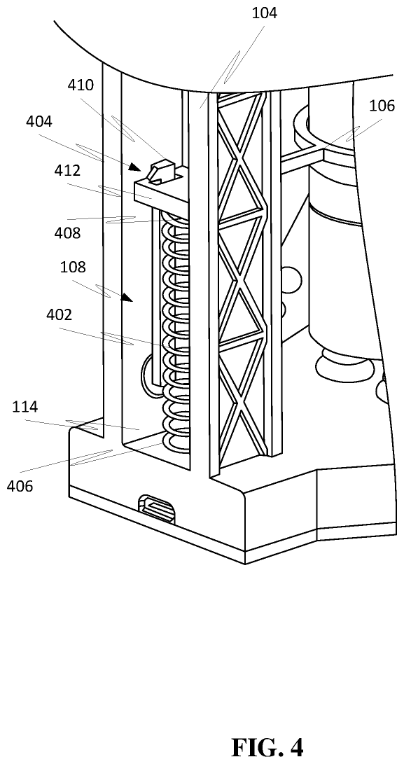

Further, in some embodiments, the support member 104 may include an interior space 302 extending between the first end 114 of the support member 104 and the second end 116 of the support member 104. Further, the movement mechanism 108 may be disposed in the interior space 302. Further, the movement mechanism 108 may include a spring 402 and a latch assembly 404, as shown in FIG. 4. Further, the spring 402 may include a first end 406 and a second end 408, as shown in FIG. 4. Further, the first end 406 of the spring 402 may be attached to the first end 114 of the support member 104. Further, the spring 402 may be configured for transitioning to a natural state of the spring 402 from at least one stressed state of the spring 402. Further, the at least one stressed state may include a compressed state and an extended state. Further, the natural state corresponds to the first state and the at least one stressed state corresponds to the at least one second state. Further, the latch assembly 404 may include a hook element 410 and a loop element 412, as shown in FIG. 4. Further, the loop element 412 may be attached to the second end 408 of the spring 402. Further, the hook element 410 may be configured to be disengagedly engaged with the loop element 412. Further, the hook element 410 may be configured for disengaging from the loop element 412 based on the actuating. Further, the transitioning of the spring 402 to the natural state from the at least one stressed state may be based on the disengaging. Further, the moving of the holding element 106 along the support member 104 may be based on the transitioning of the spring 402 to the natural state from the at least one stressed state. Further, in an instance, the spring 402 may be configured for transitioning to the at least one stressed state form the natural state by applying an external force on the spring 402.

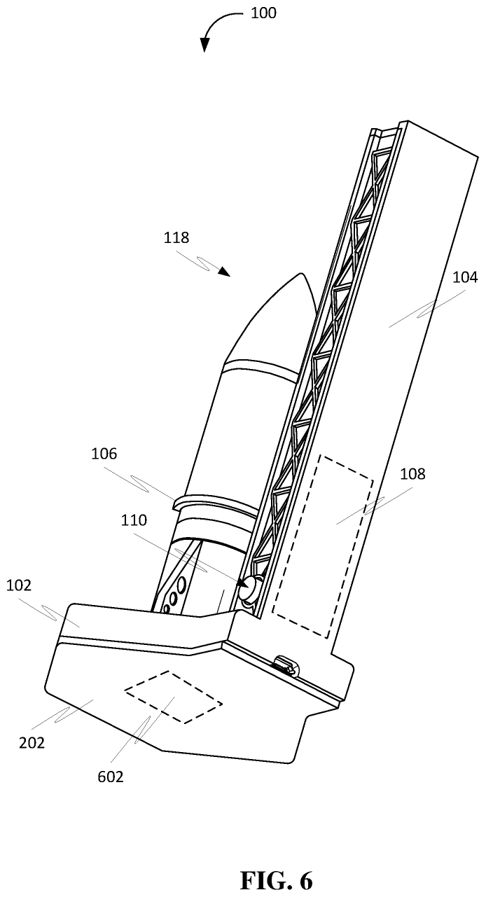

Further, in some embodiments, the actuating device 110 may be configured for generating a signal based on the actuating. Further, the apparatus 100 may include at least one output device 602, as shown in FIG. 6, communicatively coupled with the actuating device 110. Further, the at least one output device 602 may be configured for presenting at least one output based on the signal. Further, the at least one output device 602 may include a speaker, a vibrating device, a display device, etc. Further, the at least one output may include sounds, images, videos, vibrations, etc. Further, the actuating device 110 and the at least one output device 602 may be electrically powered from at least one power source. Further, the at least one power source may include a rechargeable battery.

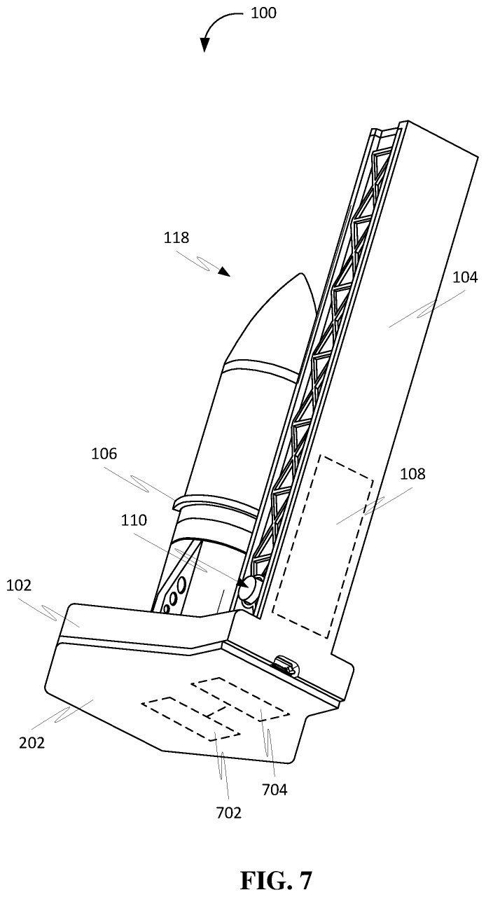

In further embodiments, the apparatus 100 may include at least one sensor 702 and a processing device 704, as shown in FIG. 7. Further, the at least one sensor 702 may include a camera, a motion sensor, an eye tracking sensor, a physiological sensor, a physical sensor, etc. Further, the at least one sensor 702 may be configured for generating at least one user data based on detecting at least one user characteristic of at least one user in relation to the apparatus 100. Further, the at least one user characteristic may include a position, an eye level, a gesture, a facial expression, a substance applied to a face, etc. of the at least one user. Further, the processing device 704 may be communicatively coupled with the at least one sensor 702. Further, the processing device 704 may be configured for analyzing the at least one user data. Further, the processing device 704 may be configured for determining a second applicator position from the at least one second applicator position based on the analyzing. Further, the processing device 704 may be configured for generating a command for the actuating device 110 based on the determining. Further, the processing device 704 may be communicatively coupled with the actuating device 110. Further, the actuating of the movement mechanism 108 may be based on the command.

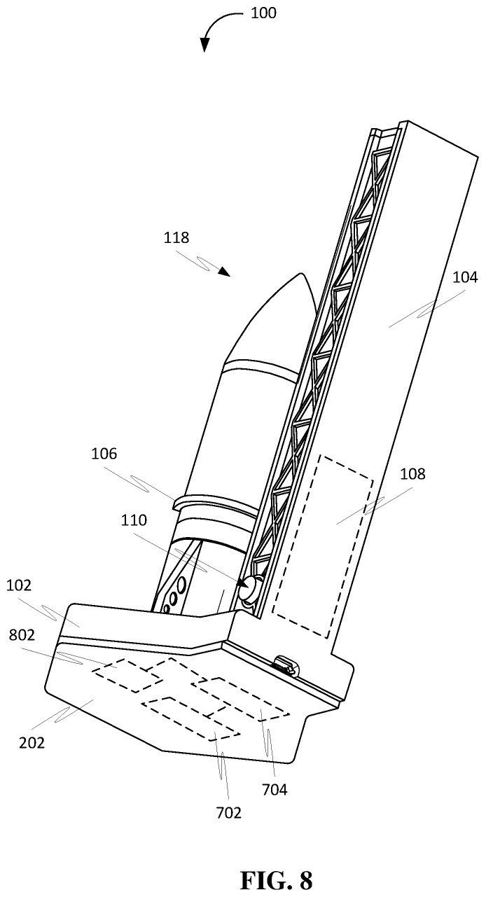

Further, in an embodiment, the processing device 704 may be configured for generating an output associated with the applicator 118 based on the determining of the second applicator position. Further, the apparatus 100 may include an output device 802, as shown in FIG. 8, communicatively coupled with the processing device 704. Further, the output device 802 may include a speaker. Further, the output device 802 may be configured for presenting the output based on the generating of the output. Further, in an embodiment, the processing device 704 may be configured for determining a duration for each of a plurality of consecutive sounds based on the determining of the second applicator position. Further, the generating of the output may be based on the determining of the duration of each of the plurality of consecutive sounds. Further, the output may include the plurality of consecutive sounds. Further, the plurality of consecutive sounds may be associated with a take-off of a rocket. Further, the plurality of consecutive sounds may include rumbling sounds, roaring sounds, whooshing sounds, etc.

Further, in an embodiment, the processing device 704 may be configured for determining an acceleration profile of an acceleration associated with the moving of the holding element 106 based on the determining of the second applicator position. Further, the generating of the command may be based on the determining of the acceleration profile. Further, the acceleration profile may be an acceleration profile of an acceleration of a rocket during a launch of a rocket. Further, the acceleration profile may include an exponential acceleration.

Further, in some embodiments, the applicator 118 may be a cosmetic product applicator. Further, the cosmetic product applicator may be used for applying a cosmetic product such as lipstick.

FIG. 2 is a bottom perspective view of the apparatus 100, in accordance with some embodiments.

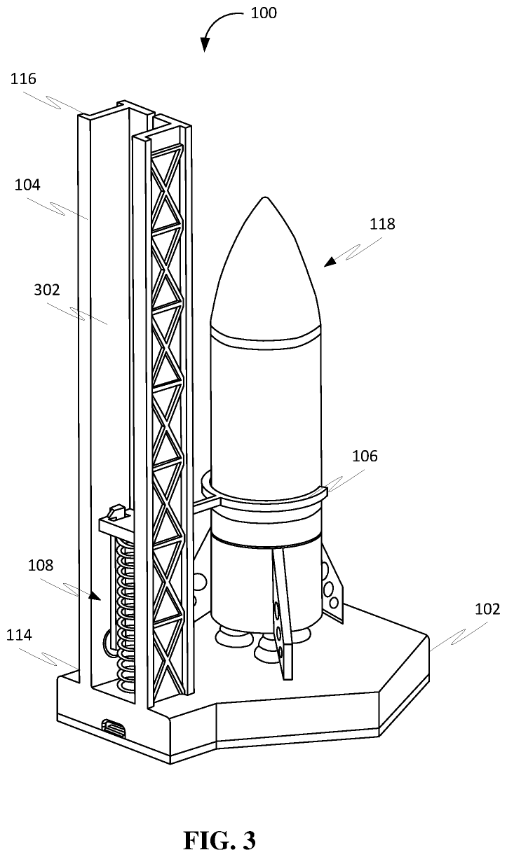

FIG. 3 is a side perspective view of the apparatus 100, in accordance with some embodiments.

FIG. 4 is a partial view of the support member 104 of the apparatus 100, in accordance with some embodiments.

FIG. 5 is a top view of the holding element 106 of the apparatus 100, in accordance with some embodiments.

FIG. 6 is a bottom perspective view of the apparatus 100, in accordance with some embodiments.

FIG. 7 is a bottom perspective view of the apparatus 100, in accordance with some embodiments.

FIG. 8 is a bottom perspective view of the apparatus 100, in accordance with some embodiments.

FIG. 9 is a top perspective view of the receiving element 506 of the holding element 106, in accordance with some embodiments.

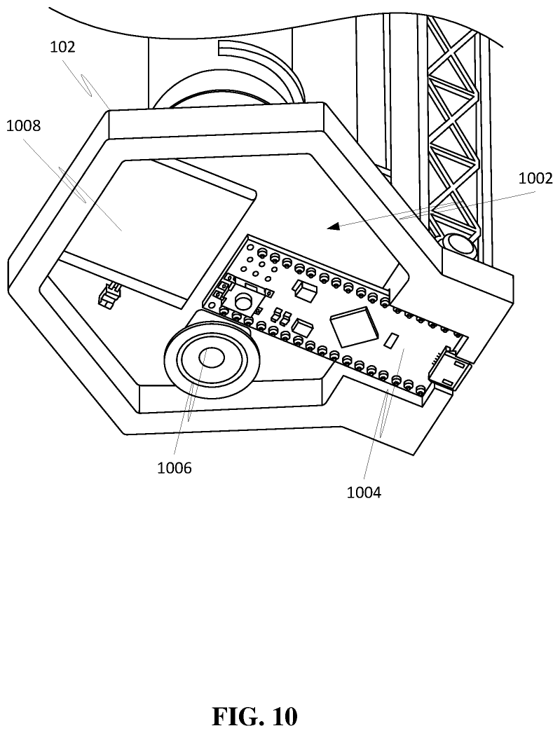

FIG. 10 is a partial bottom perspective view of the base 102 of the apparatus 100, in accordance with some embodiments. Further, the base 102 may include a base interior space 1002. Further, the base 102 may include a microcontroller 1004, a speaker 1006, and a battery 1008 disposed in the base interior space 1002. Further, the battery 1008 may be rechargeable. Further, the battery 1008 may be electrically coupled with the microcontroller 1004 and the speaker 1006 for powering the microcontroller 1004 and the speaker 1006. Further, the microcontroller 1004 may be communicatively coupled with the speaker 1006

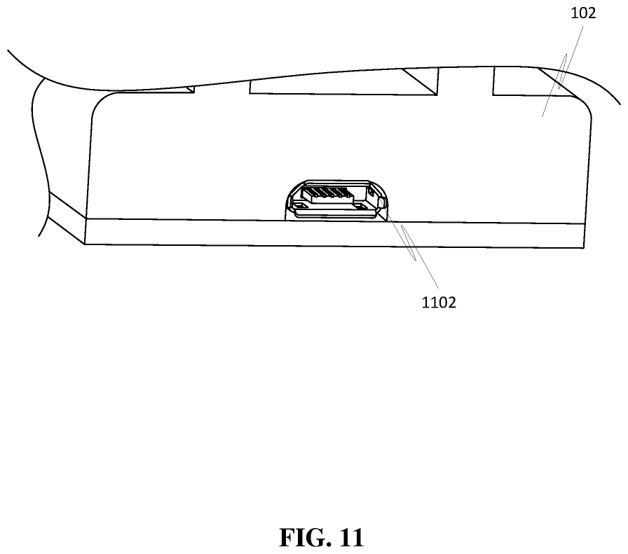

FIG. 11 is a partial rear view of the base 102 of the apparatus 100, in accordance with some embodiments. Further, the base 102 may include a charging port 1102. Further, the charging port 1102 may be electrically coupled with the battery 1008. Further, the charging port 1102 may be used for charging the battery 1008.

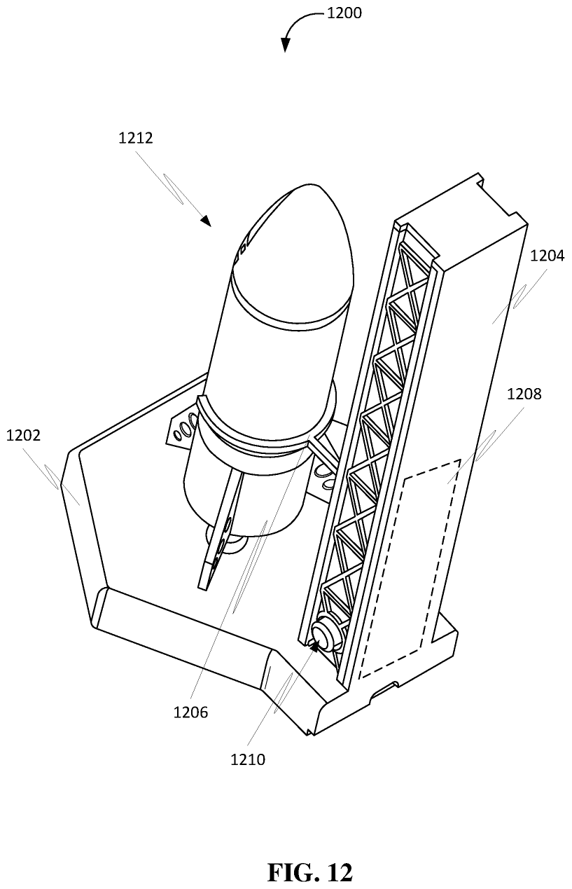

FIG. 12 is a top perspective view of an apparatus 1200 for facilitating dispensing of applicators, in accordance with some embodiments. Accordingly, the apparatus 1200 may include an applicator 1212, a base 1202, a support member 1204, a holding element 1206, a movement mechanism 1208, and an actuating device 1210.

Further, the applicator 1212 may include an applicator housing. Further, the applicator housing may include an applicator housing base and an applicator housing body. Further, the applicator housing body may be cylindrically shaped.

Further, the base 1202 may include a bottom surface and a top surface opposing the bottom surface. Further, the base 1202 may be disposable on a surface. Further, the apparatus 1200 may be placed on the surface based on the disposing of the base 1202.

Further, the support member 1204 may be coupled to the base 1202. Further, the support member 1204 extends between a first end and a second end. Further, the first end of the support member 1204 may be attached to the top surface. Further, the second end of the support member 1204 extends away from the top surface.

Further, the holding element 1206 may be movably coupled to the support member 1204. Further, the holding element 1206 may be configured for holding the applicator 1212.

Further, the movement mechanism 1208 may be coupled to the holding element 1206 and the support member 1204. Further, the movement mechanism 1208 may be configured for moving the holding element 1206 along the support member 1204 from a first position of the holding element 1206 to at least one second position of the holding element 1206. Further, the moving of the holding element 1206 moves the applicator 1212 from a first applicator position of the applicator 1212 to at least one second applicator position of the applicator 1212 based on the holding. Further, the first position corresponds to the first applicator position and the at least one second position corresponds to the at least one second applicator position.

Further, the actuating device 1210 may be operatively coupled with the movement mechanism 1208. Further, the actuating device 1210 may be configured for actuating the movement mechanism 1208. Further, the moving of the holding element 1206 may be based on the actuating.

Further, in some embodiments, the actuating device 1210 may include an input device. Further, the input device may be configured for receiving an input action. Further, the actuating of the movement mechanism 1208 may be based on the receiving of the input action.

Further, in some embodiments, the holding element 1206 extends between a first end and a second end. Further, the first end of the holding element 1206 may be coupled to the movement mechanism 1208. Further, the holding element 1206 may include a receiving element comprised in the second end of the holding element 1206. Further, the receiving element may be configured for receiving the applicator 1212 for securing the applicator 1212 to the holding element 1206. Further, the holding of the applicator 1212 may be based on the securing.

Further, in some embodiments, the applicator 1212 may be removably securable to the holding element 1206.

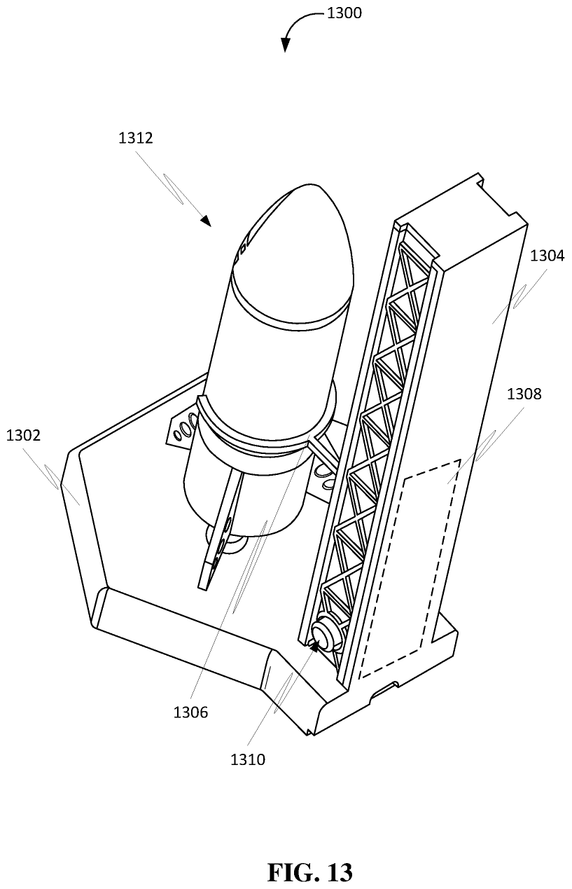

FIG. 13 is a top perspective view of an apparatus 1300 for facilitating dispensing of applicators, in accordance with some embodiments. Accordingly, the apparatus 1300 may include an applicator 1312, a base 1302, a support member 1304, a holding element 1306, a movement mechanism 1308, and an actuating device 1310.

Further, the applicator 1312 may include an applicator housing. Further, the applicator housing may include an applicator housing base and an applicator housing body. Further, the applicator housing body may be cylindrically shaped. Further, the applicator 1312 may be a cosmetic product applicator.

Further, the base 1302 may include a bottom surface and a top surface opposing the bottom surface. Further, the base 1302 may be disposable on a surface. Further, the apparatus 1300 may be placed on the surface based on the disposing of the base 1302.

Further, the support member 1304 may be coupled to the base 1302. Further, the support member 1304 extends between a first end and a second end. Further, the first end of the support member 1304 may be attached to the top surface. Further, the second end of the support member 1304 extends away from the top surface. Further, the support member 1304 may include an interior space extending between the first end of the support member 1304 and the second end of the support member 1304.

Further, the holding element 1306 may be movably coupled to the support member 1304. Further, the holding element 1306 may be configured for holding the applicator 1312.

Further, the movement mechanism 1308 may be coupled to the holding element 1306 and the support member 1304. Further, the movement mechanism 1308 may be configured for moving the holding element 1306 along the support member 1304 from a first position of the holding element 1306 to at least one second position of the holding element 1306. Further, the moving of the holding element 1306 moves the applicator 1312 from a first applicator position of the applicator 1312 to at least one second applicator position of the applicator 1312 based on the holding. Further, the first position corresponds to the first applicator position and the at least one second position corresponds to the at least one second applicator position. Further, the movement mechanism 1308 may be disposed in the interior space. Further, the movement mechanism 1308 may include a spring and a latch assembly. Further, the spring may include a first end and a second end. Further, the first end of the spring may be attached to the first end of the support member 1304. Further, the spring may be configured for transitioning to a natural state of the spring from at least one stressed state of the spring. Further, the natural state corresponds to the first state and the at least one stressed state corresponds to the at least one second state. Further, the latch assembly may include a hook element and a loop element. Further, the loop element may be attached to the second end of the spring. Further, the hook element may be configured to be disengagedly engaged with the loop element.

Further, the actuating device 1310 may be operatively coupled with the movement mechanism 1308. Further, the actuating device 1310 may be configured for actuating the movement mechanism 1308. Further, the moving of the holding element 1306 may be based on the actuating. Further, the hook element may be configured for disengaging from the loop element based on the actuating. Further, the transitioning of the spring to the natural state from the at least one stressed state may be based on the disengaging. Further, the moving of the holding element 1306 along the support member 1304 may be based on the transitioning of the spring to the natural state from the at least one stressed state.

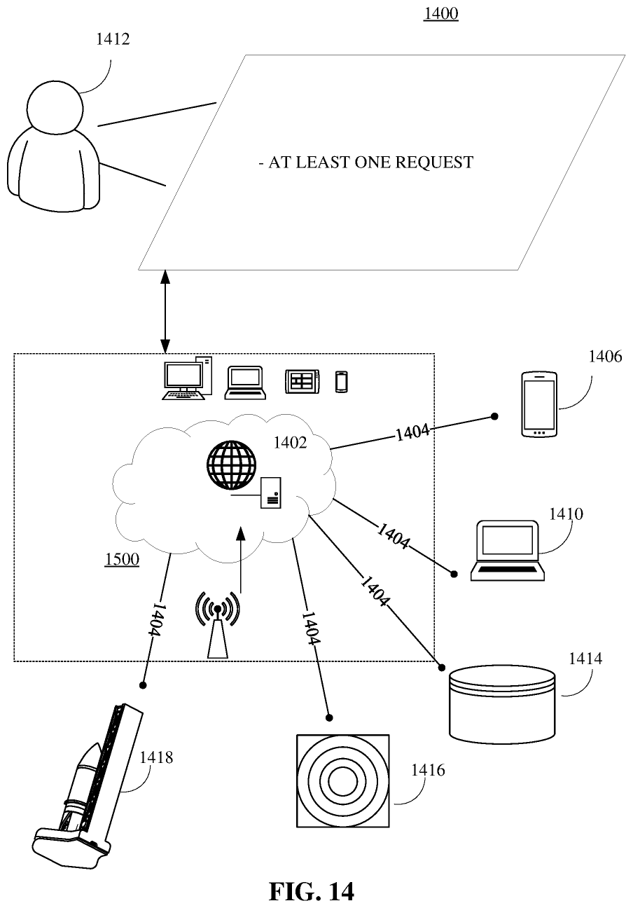

FIG. 14 is an illustration of an online platform 1400 consistent with various embodiments of the present disclosure. By way of non-limiting example, the online platform 1400 to facilitate dispensing of applicators may be hosted on a centralized server 1402, such as, for example, a cloud computing service. The centralized server 1402 may communicate with other network entities, such as, for example, a mobile device 1406 (such as a smartphone, a laptop, a tablet computer, etc.), other electronic devices 1410 (such as desktop computers, server computers, etc.), databases 1414, sensors 1416, and an apparatus 1418 (such as the apparatus 100, the apparatus 1200, and the apparatus 1300) over a communication network 1404, such as but not limited to, the Internet. Further, users of the online platform 1400 may include relevant parties such as, but not limited to, end-users, administrators, and so on. Accordingly, in some instances, electronic devices operated by the one or more relevant parties may be in communication with the platform.

A user 1412, such as the one or more relevant parties, may access online platform 1400 through a web based software application or browser. The web based software application may be embodied as, for example, but not be limited to, a website, a web application, a desktop application, and a mobile application compatible with a computing device 1500.

Further, in an instance, the online platform 1400 may include a communication device configured for receiving at least one request from at least one user device (client device). Further, the online platform 1400 may include a processing device communicatively coupled with the communication device. Further, the processing device may be configured for analyzing the at least one request. Further, the processing device may be configured for determining a position for an applicator based on the analyzing. Further, the processing device may be configured for generating a command for the apparatus 1418. Further, the apparatus 1418 may be communicatively coupled with the processing device. Further, the apparatus 1418 may be configured for moving the applicator to the position based on the command.

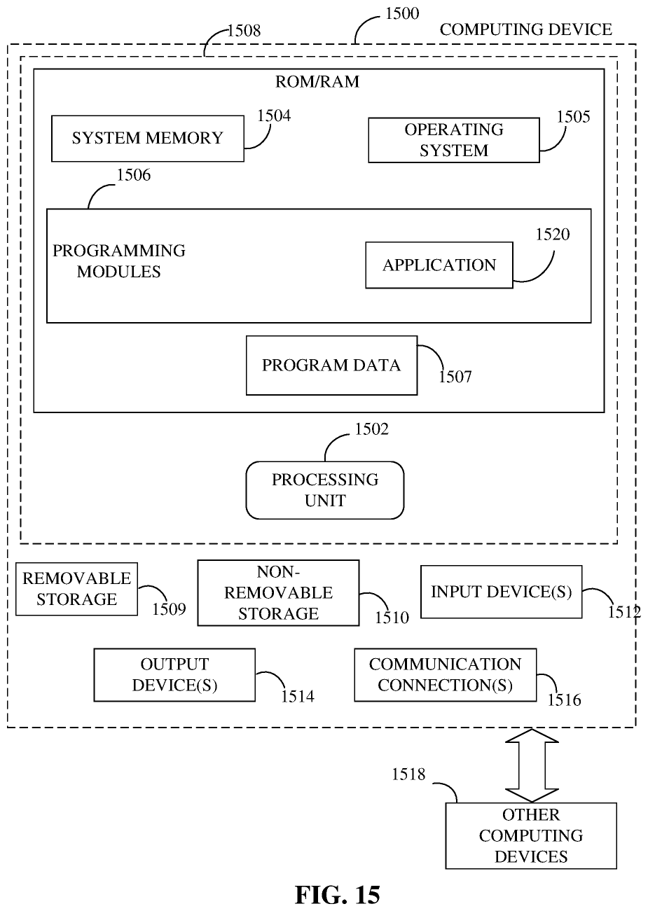

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing modules. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include image processing applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for facilitating dispensing of applicators, the apparatus comprising:
a base comprising a bottom surface and a top surface opposing the bottom surface, wherein the base is disposable on a surface, wherein the apparatus is placed on the surface based on the disposing of the base;
a support member coupled to the base, wherein the support member extends between a first end and a second end, wherein the first end of the support member is attached to the top surface, wherein the second end of the support member extends away from the top surface;
a holding element movably coupled to the support member, wherein the holding element is configured for holding an applicator;
a movement mechanism coupled to the holding element and the support member, wherein the movement mechanism is configured for moving the holding element along the support member from a first position of the holding element to at least one second position of the holding element, wherein the moving of the holding element moves the applicator from a first applicator position of the applicator to at least one second applicator position of the applicator based on the holding, wherein the first position corresponds to the first applicator position and the at least one second position corresponds to the at least one second applicator position; and
an actuating device operatively coupled with the movement mechanism, wherein the actuating device is configured for actuating the movement mechanism, wherein the moving of the holding element is based on the actuating.

2. The apparatus of claim 1, wherein the actuating device comprises an input device, wherein the input device is configured for receiving an input action, wherein the actuating of the movement mechanism is based on the receiving of the input action.

3. The apparatus of claim 1, wherein the holding element extends between a first end and a second end, wherein the first end of the holding element is coupled to the movement mechanism, wherein the holding element comprises a receiving element comprised in the second end of the holding element, wherein the receiving element is configured for receiving the applicator for securing the applicator to the holding element, wherein the holding of the applicator is based on the securing.

4. The apparatus of claim 3, wherein the receiving element comprises a housing, wherein the housing comprises a housing interior space and a housing opening leading into the housing interior space, wherein the housing is configured for receiving the applicator in the housing interior space, wherein the receiving of the applicator is based on the receiving of the applicator into the housing interior space.

5. The apparatus of claim 4, wherein the housing comprises a housing base and a housing body, wherein the housing base is attached to a first end of the housing body, wherein the housing body defines the housing interior space, wherein the housing body further defines the housing opening at a second end of the housing body, wherein the housing body is cylindrically shaped.

6. The apparatus of claim 1 further comprising the applicator securable to the holding element, wherein the applicator comprises an applicator housing, wherein the applicator housing comprises an applicator housing base and an applicator housing body, wherein the applicator housing body is cylindrically shaped.

7. The apparatus of claim 6, wherein the applicator is removably securable to the holding element.

8. The apparatus of claim 1, wherein the holding element is further configured for releasably holding the applicator.

9. The apparatus of claim 1, wherein the support member comprises an interior space extending between the first end of the support member and the second end of the support member, wherein the movement mechanism is disposed in the interior space, wherein the movement mechanism comprises a spring and a latch assembly, wherein the spring comprises a first end and a second end, wherein the first end of the spring is attached to the first end of the support member, wherein the spring is configured for transitioning to a natural state of the spring from at least one stressed state of the spring, wherein the natural state corresponds to the first state and the at least one stressed state corresponds to the at least one second state, wherein the latch assembly comprising a hook element and a loop element, wherein the loop element is attached to the second end of the spring, wherein the hook element is configured to be disengagedly engaged with the loop element, wherein the hook element is configured for disengaging from the loop element based on the actuating, wherein the transitioning of the spring to the natural state from the at least one stressed state is based on the disengaging, wherein the moving of the holding element along the support member is based on the transitioning of the spring to the natural state from the at least one stressed state.

10. The apparatus of claim 1, wherein the actuating device is further configured for generating a signal based on the actuating, wherein the apparatus further comprises at least one output device communicatively coupled with the actuating device, wherein the at least one output device is configured for presenting at least one output based on the signal.

11. The apparatus of claim 1 further comprising:
at least one sensor configured for generating at least one user data based on detecting at least one user characteristic of at least one user in relation to the apparatus; and
a processing device communicatively coupled with the at least one sensor, wherein the processing device is configured for:
analyzing the at least one user data;
determining a second applicator position from the at least one second applicator position based on the analyzing; and
generating a command for the actuating device based on the determining, wherein the processing device is communicatively coupled with the actuating device, wherein the actuating of the movement mechanism is based on the command.

12. The apparatus of claim 11, wherein the processing device is further configured for generating an output associated with the applicator based on the determining of the second applicator position, wherein the apparatus further comprises an output device communicatively coupled with the processing device, wherein the output device is configured for presenting the output based on the generating of the output.

13. The apparatus of claim 12, wherein the processing device further is configured for determining a duration for each of a plurality of consecutive sounds based on the determining of the second applicator position, wherein the generating of the output is further based on the determining of the duration of each of the plurality of consecutive sounds, wherein the output comprises the plurality of consecutive sounds.

14. The apparatus of claim 11, wherein the processing device is further configured for determining an acceleration profile of an acceleration associated with the moving of the holding element based on the determining of the second applicator position, wherein the generating of the command is further based on the determining of the acceleration profile.

15. The apparatus of claim 1, wherein the applicator is a cosmetic product applicator.

16. An apparatus for facilitating dispensing of applicators, the apparatus comprising:
an applicator comprising an applicator housing, wherein the applicator housing comprises an applicator housing base and an applicator housing body, wherein the applicator housing body is cylindrically shaped;
a base comprising a bottom surface and a top surface opposing the bottom surface, wherein the base is disposable on a surface, wherein the apparatus is placed on the surface based on the disposing of the base;
a support member coupled to the base, wherein the support member extends between a first end and a second end, wherein the first end of the support member is attached to the top surface, wherein the second end of the support member extends away from the top surface;
a holding element movably coupled to the support member, wherein the holding element is configured for holding the applicator;
a movement mechanism coupled to the holding element and the support member, wherein the movement mechanism is configured for moving the holding element along the support member from a first position of the holding element to at least one second position of the holding element, wherein the moving of the holding element moves the applicator from a first applicator position of the applicator to at least one second applicator position of the applicator based on the holding, wherein the first position corresponds to the first applicator position and the at least one second position corresponds to the at least one second applicator position; and
an actuating device operatively coupled with the movement mechanism, wherein the actuating device is configured for actuating the movement mechanism, wherein the moving of the holding element is based on the actuating.

17. The apparatus of claim 16, wherein the actuating device comprises an input device, wherein the input device is configured for receiving an input action, wherein the actuating of the movement mechanism is based on the receiving of the input action.

18. The apparatus of claim 16, wherein the holding element extends between a first end and a second end, wherein the first end of the holding element is coupled to the movement mechanism, wherein the holding element comprises a receiving element comprised in the second end of the holding element, wherein the receiving element is configured for receiving the applicator for securing the applicator to the holding element, wherein the holding of the applicator is based on the securing.

19. The apparatus of claim 16, wherein the applicator is removably securable to the holding element.

20. An apparatus for facilitating dispensing of applicators, the apparatus comprising:
an applicator comprising an applicator housing, wherein the applicator housing comprises an applicator housing base and an applicator housing body, wherein the applicator housing body is cylindrically shaped, wherein the applicator is a cosmetic product applicator;
a base comprising a bottom surface and a top surface opposing the bottom surface, wherein the base is disposable on a surface, wherein the apparatus is placed on the surface based on the disposing of the base;
a support member coupled to the base, wherein the support member extends between a first end and a second end, wherein the first end of the support member is attached to the top surface, wherein the second end of the support member extends away from the top surface, wherein the support member comprises an interior space extending between the first end of the support member and the second end of the support member;
a holding element movably coupled to the support member, wherein the holding element is configured for holding the applicator;
a movement mechanism coupled to the holding element and the support member, wherein the movement mechanism is configured for moving the holding element along the support member from a first position of the holding element to at least one second position of the holding element, wherein the moving of the holding element moves the applicator from a first applicator position of the applicator to at least one second applicator position of the applicator based on the holding, wherein the first position corresponds to the first applicator position and the at least one second position corresponds to the at least one second applicator position, wherein the movement mechanism is disposed in the interior space, wherein the movement mechanism comprises a spring and a latch assembly, wherein the spring comprises a first end and a second end, wherein the first end of the spring is attached to the first end of the support member, wherein the spring is configured for transitioning to a natural state of the spring from at least one stressed state of the spring, wherein the natural state corresponds to the first state and the at least one stressed state corresponds to the at least one second state, wherein the latch assembly comprising a hook element and a loop element, wherein the loop element is attached to the second end of the spring, wherein the hook element is configured to be disengagedly engaged with the loop element; and
an actuating device operatively coupled with the movement mechanism, wherein the actuating device is configured for actuating the movement mechanism, wherein the moving of the holding element is based on the actuating, wherein the hook element is configured for disengaging from the loop element based on the actuating, wherein the transitioning of the spring to the natural state from the at least one stressed state is based on the disengaging, wherein the moving of the holding element along the support member is based on the transitioning of the spring to the natural state from the at least one stressed state.
